(19) United States
(12) Patent Application Publication
(10) Pub. No.: US 2012/0213955 A1
(43) Pub. Date: Aug. 23, 2012

(54) METHOD FOR MANUFACTURING A SHELL BODY AND CORRESPONDING BODY

(75) Inventors: Steffen Biesek, Hamburg (DE); Robert Alexander Goehlich, Hamburg (DE); Cihangir Sayilgan, Hamburg (DE)

(73) Assignee: AIRBUS OPERATIONS GMBH, Hamburg (DE)

(21) Appl. No.: 13/212,832

(22) Filed: Aug. 18, 2011

Related U.S. Application Data
(63) Continuation of application No. PCT/EP2010/051987, filed on Feb. 17, 2010.
(60) Provisional application No. 61/153,534, filed on Feb. 18, 2009.

(30) Foreign Application Priority Data
Feb. 18, 2009 (DE) 10 2009 009 491.1

(51) Int. Cl. B32B 1/04; B64C 1/06; B32B 38/00

(52) U.S. Cl. 428/34.1; 156/221

(57) ABSTRACT

In a method for manufacturing a shell, at least two shell sections are fabricated out of a composite fiber material, at least one compensation body of a plastically deformable material is secured to at least one limiting edge of at least one shell section, the shell sections are overlapped to form the shell, yielding flat seams between respectively adjacent shell sections. The at least one compensation body is arranged on at least one of the seams. In order to compensate for dimensional deviations in each overlap, the shape of the corresponding compensation bodies is changed, and the shells sections are joined together at the seams.

### CROSS REFERENCE TO RELATED APPLICATIONS

This application is a continuation of International Application No. PCT/EP2010/051987, filed 17 Feb. 2010, which was published under PCT Article 21(2) and which claims priority to German Patent Application No. 10 2009 009 491.1 filed Feb. 18, 2009 and of U.S. Provisional Patent Application No. 61/153,534 filed Feb. 18, 2009, the disclosure of which applications is hereby incorporated herein by reference.

### TECHNICAL FIELD

The technical field relates to a method for manufacturing a shell body, a shell section for a shell body, a shell body, a fuselage section of a vehicle, as well as a vehicle, for example an aircraft.

### BACKGROUND

In order to manufacture large-sized shell bodies, several shell sections are usually fabricated separately from each other, and then assembled and joined together into a shell body. This method has proven itself in vehicle construction, in particular the production of aircraft fuselages, since it is distinctly easier to handle individual, small shell sections during their reinforcement and surface treatment than it is large-format, one-piece and self-contained shell bodies.

Given the separate fabrication of shell sections, it cannot be guaranteed that the shell sections will fit together in a completely flush manner right away when the shell body is being assembled, since the deviations from the desired geometry have a greater impact in particular for larger shell sections even at very narrow tolerances, and the limiting edges of the shell sections might diverge relative to each other. However, the shape of the shell sections can be easily corrected when using metal materials, in that the shell sections undergo slight plastic deformation when correspondingly bent.

However, this is not easily possible when using modern composite fiber materials for manufacturing large-format shells, since CFRP or GRP exhibit an extremely high strength that allows virtually no deformation, even within narrow limits. As a consequence, the geometries of a shell section cannot be adjusted to offset dimensional deviations in the case of shell sections fabricated out of composite fiber materials without jeopardizing their integrity.

One conceivable alternative to the plastic deformation of shell sections for shell sections made out of composite fibers would be to thicken the respectively facing limiting edges, so as to compensate for dimensional deviations by removing material from the outer surface. However, this would be very labor-intensive and time-consuming, and may also adversely impact the integrity of the shell sections. Another way out of this problem would be to produce single-piece shell bodies, which would be very complicated and expensive in light of size considerations in vehicle construction, in particular aircraft construction.

Therefore, at least one object may be regarded as proposing a method for manufacturing a shell that makes it possible to both fabricate the shell body in multiple sections and easily compensate for dimensional deviations. In addition, other objects, desirable features and characteristics will become apparent from the subsequent summary and detailed description, and the appended claims, taken in conjunction with the accompanying drawings and this background.

### SUMMARY

A method for manufacturing a shell according to the invention may be comprised of the procedural steps described below. At least two shell sections are fabricated out of a composite fiber material, wherein each shell section exhibits at least one limiting edge. At least one compensation body made out of a plastically deformable material is attached for at least one limiting edge. For example, such a compensation body may here be secured to each shell section at each limiting edge, or only one respective compensation body may be attached to each shell section; however, two compensation bodies may also be secured to one shell section, with no such compensation body being attached to the other shell section. The shell sections fabricated and outfitted in this way are overlapped with each other to form the shell body, yielding flat seams between respectively adjacent shell sections, wherein the at least one compensation body is arranged on at least one of the seams.

This type of compensation body made out of a plastically deformable material provides a way to compensate for a dimensional deviation between abutting shell sections by mechanically changing the shape of the compensation body. For example, if the shell sections are configured as cylinder barrel segments with limiting edges running parallel to the longitudinal axis of a resultant cylindrical shell body, these limiting edges might diverge over their length given especially large shell sections. If divergent shell sections like these were to be overlapped, the shell sections would not come to contact each other in a flat and flush manner in the provided seam, thereby resulting in stresses and damage to the shell sections in proximity to the seam when joining together the two shell sections.

However, if a compensation body and shell section or two compensation bodies are made to overlap, wherein the compensation bodies are each rigidly joined with a shell section, the shape of the plastically deformable deformation bodies would be very easy to correct, so that a flat contact can be established inside the seam. As a result, stress and damage to the shell sections may also be prevented. This makes sense in particular when fabricating shell sections out of carbon fiber composite materials, which in a cured state are virtually impossible to change in terms of their shape.

The assembly outlay for the shell body can be reduced by lowering the number of shell divisions. In an ideal case, it would be conceivable to combine only two shell sections into a shell body, resulting in only two flat seams, in which at least one respective compensation body is arranged. However, the method according to the invention may also be broadened to comprise more shell sections to be joined together, so that the advantages according to the invention are not negatively impacted.

The method permits tolerance compensation relative to large shell sections manufactured in CFRP construction method, too. A two-shell configuration for a shell body is hence very easy to handle. The enabled larger shell sections reduce the overall assembly outlay. By comparison to conventional manufacturing methods, the reduced number of shell sections, and hence seams, also cuts the number of required binding elements for joining together the shell sections, thereby yielding a savings in weight. Another major advantage lies in the fact that the flat seams allow force to be transferred between the conjoined shell sections especially well and also homogeneously by comparison with linear seams.

In an especially preferred further development of the method, the compensation body is laminated into the composite fiber material of the respective shell section. When manufacturing the shell section out of a composite fiber material, fiber mats or fiber plies are usually joined with a matrix material, for example, so that a compensation body can be introduced into a limiting edge before the composite fiber material is cured, and then rigidly joined thereto after the composite fiber material has been cured. As one possible adjustment, the compensation body may comprise depressions, recesses or the like in a region enveloped by the composite fiber material. This may yield an improved adhesion of the compensation body, similarly to wire reinforcement.

In another advantageous further development of the method, the compensation body may also be secured to the respective shell section in a positive joining procedure. To this end, it may be possible to provide the shell section with matching recesses, rivets, bushings or the like to ensure the best possible load introduction in the compensation body.

In another advantageous further development of the method, a plurality of compensation bodies is arranged on the shell sections, so that at least one compensation body is situated in all seams. When especially large shells are to be fabricated, this makes it possible to properly compensate for the dimensional softening of any seam.

In another embodiment of the method, the compensation body may be configured as a fold-like element, whose contour always follows the contour of the shell section. As a result, local peak loads on the structure may be ameliorated.

In another further development of the method, at least areas of the respective shell sections may be molded as a cylinder barrel segment during the fabrication of vehicle fuselages and especially aircraft fuselages, for example, making it possible to realize a compensation body as an oblong, strip-like extension on the limiting edges of the shell sections. This is especially simple to manufacture, and especially easy to adjust in terms of shape, so as to eliminate dimensional deviations.

In another further development of the method, the at least one compensation body may be fabricated out of a metal material. While it is recommended that titanium be used for achieving an especially advantageous weight-to-strength ratio, other materials are also possible. The object is further met by a shell section consisting of a composite fiber material having at least one limiting edge, which has at least one compensation body comprised of a plastically deformable material arranged at the at least one limiting edge in order to compensate for dimensional deviations. For example, a shell may be composed of several of these shell sections. However, the manufacturing costs may also be conceivably reduced by joining a shell section with two limiting edges and a respective compensation body to a limiting edge having a shell section that does exhibit two limiting edges, but not its own compensation body. The dimensional deviations may be compensated accordingly by introducing dimensional changes in the compensation body of the one shell section according to the invention.

Similarly, a shell body is provided with a composite fiber material having at least one of the above shell sections according to the invention. In like manner, a fuselage section is provided for a vehicle, for example an aircraft, having at least one shell body. The shell body is composed of at least one shell section and another shell section. Further, a vehicle is provided with at least one fuselage section.

### BRIEF DESCRIPTION OF THE DRAWINGS

Additional features, advantages and possible applications of the present invention may be gleaned from the following description of the exemplary embodiments and the figures. In this case, all described and/or graphically illustrated features constitute the subject matter of the invention taken alone and in any combination, even independently of their composition in the individual claims or back references thereto. In addition, the same reference numbers on the figures stand for identical or similar objects.

FIG. 1 shows a conventional method for fabricating a shell based on two shell sections;

FIG. 2 shows a diagrammatic overview of the method according to an embodiment of the invention for fabricating a shell based on two shell sections;

FIG. 3 shows a three-dimensional view of a shell section according to an embodiment of the invention with two compensation bodies;

FIG. 4a and FIG. 4b show a diagrammatic overview of the shell with three or four shell sections;

FIG. 5 provides an overview of the method according to an embodiment of the invention for fabricating a shell according to an embodiment of the invention; and

FIG. 6 shows an aircraft having at least one fuselage section manufactured out of a shell according to an embodiment of the invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

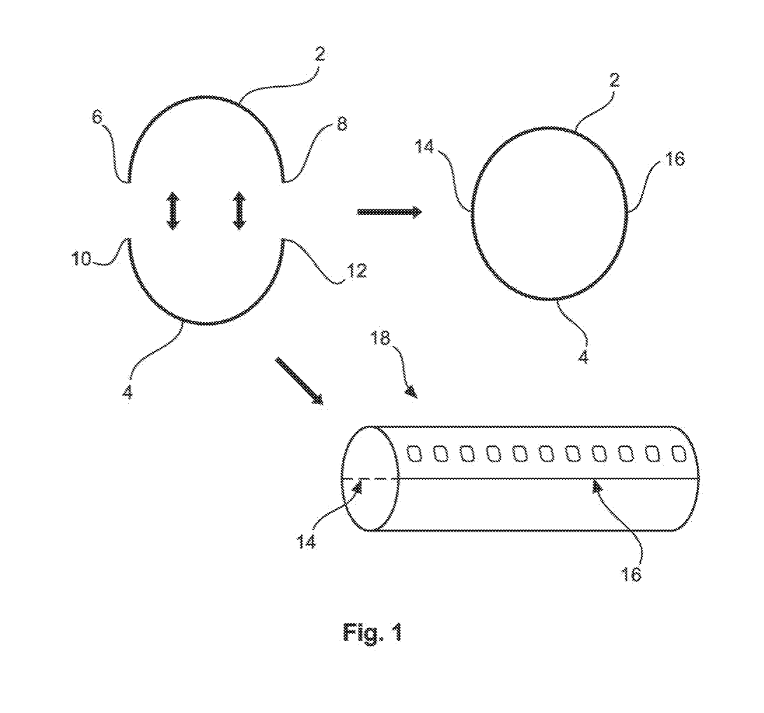

FIG. 1 shows an example of how several shell sections comprised of composite fiber materials can be joined together into a single shell according to current, conventional methods. Two shells sections 2 and 4 are depicted here as an example, which are designed as cylinder barrel segments and placed on top of each other, so that limiting edges 6 and 8 of the upper shell section 2 can be joined with limiting edges 10 and 12 of the lower shell section 4. For example, the connection is established with a series of binding elements, which are distributed over the seams 14 and 16. Fuselage sections 18 of an aircraft can be fabricated out of the latter, for example.

Shell sections fabricated in a CFRP construction method eliminate the need for correcting dimensional deviations during assembly, since CFRP shell sections can only be minimally deformed once in the cured state. Very narrow tolerances are required to mount the two shell sections 2 and 4 over a long area using a conventional method of construction, so that the limiting edges 6 and 10 or 8 and 12 run along a single line. It is very cost-intensive if not impossible to ensure compliance with these narrow tolerances using current manufacturing processes.

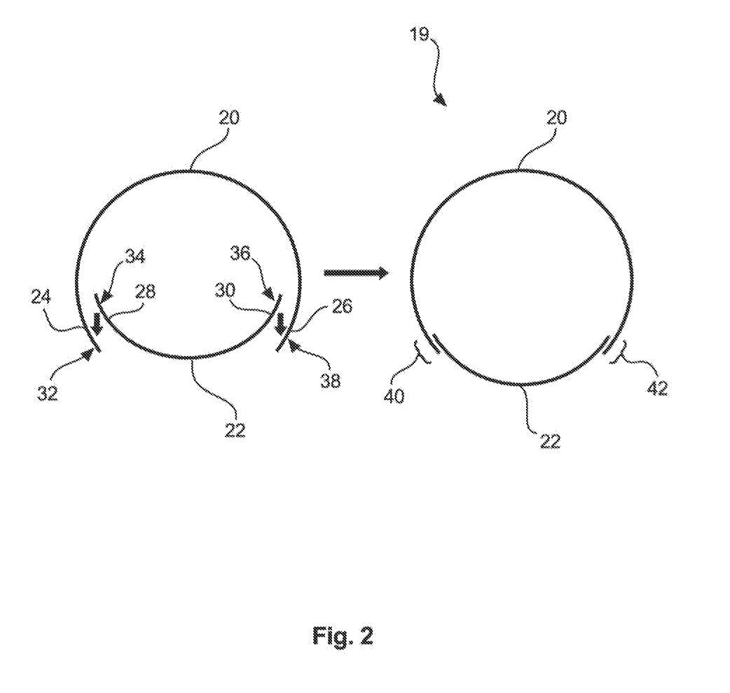

In FIG. 2 the method according to an embodiment of the invention for fabricating a shell 19 is shown. In this example, an upper shell section 20 and lower shell section 22 are joined together. Both shell sections 20 and 22 exhibit limiting edges 24, 26, 28 and 30. As an example, compensation bodies 32, 34, 36 and 38 are arranged on each of these limiting edges 24-30. While the shell sections 20 and 22 are manufactured out of a composite fiber material, for example CFRP, the compensation bodies 32 to 38 are made out of a metal material that can be plastically deformed.

When joining together the shell sections 20 and 22, flat seams 40 and 42 come about, in which the shell sections 20 and 22 overlap. In the example shown, the overlap is realized by the compensation bodies 32 to 38, the shape of which can be changed should limiting edges 24-30 exhibit dimensional deviations. The seams 40 and 42 can be corrected through slight bending so as to establish a flush contact between the compensation bodies 32-38 or shell sections 20 and 22. The two shell sections 20 and 22 can then be connected with each other at the seams 40 and 42 using conventional joining methods.

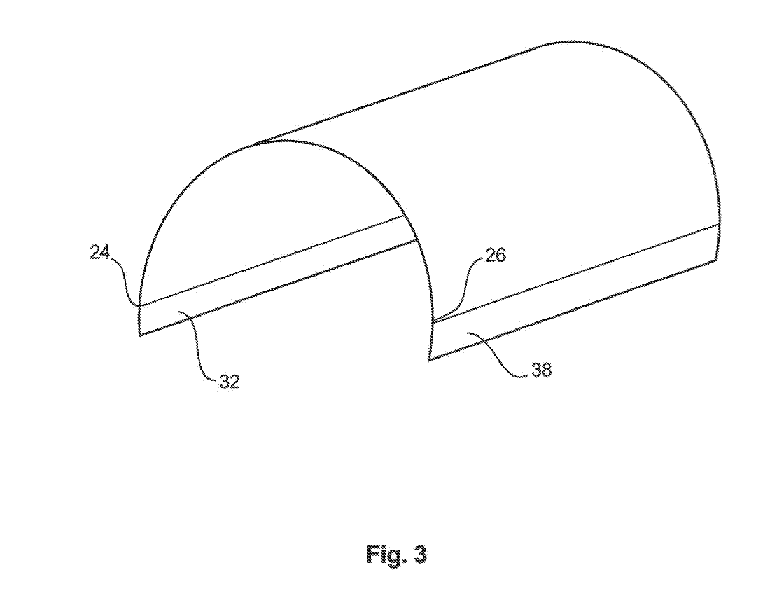

FIG. 3 shows an example of the upper shell section 20, which is configured as a cylinder barrel segment. Situated on the limiting edges 24 and 26 are compensation bodies 32 and 38, which are used to compensate for dimensional deviations. These compensation bodies 32 and 38 are preferably designed in such a way that their shape constantly follows the shape of the upper shell section 20. By avoiding discontinuities, structural load peaks can be minimized or even eliminated entirely.

The compensation bodies 32 and 38 may be made out of titanium or some other metal, so as to provide an optimal plastic deformability accompanied by strength. In addition to joining via conventional methods, such as riveting, screwing or the like, modern adhesive bonding and welding procedures may also be used. On the other hand, a completely integral material connection may also be established with the upper shell section 20, for example by way of lamination or the like.

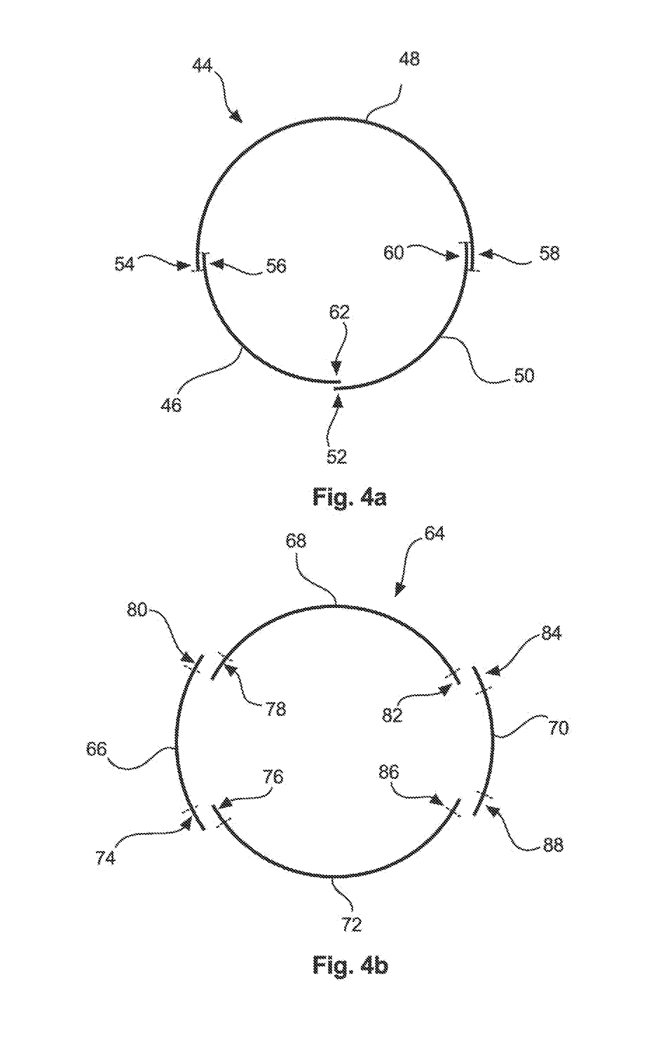

FIG. 4a presents an example for a shell 44 comprised of three shell sections 46, 48 and 50. Compensation bodies 52 to 62 may also be arranged on these shell sections 46 to 50, making it possible to compensate for dimensional deviations. Finally, FIG. 4b depicts another variant of a shell 64, which makes use of four shell sections 66 to 72 that accommodate compensation bodies 74 to 88. Of course, a single compensation body may suffice for each seam, and a compensation body inside a single seam may potentially also be entirely omitted given a shell divided into three or four sections, for example, so that only at least two compensation bodies are used for a three-section shell, and at least two or three compensation bodies are used for a four-section shell. In addition, the relevant expert knows that a division into more than four shell sections may take place without having to depart from the idea underlying the invention.

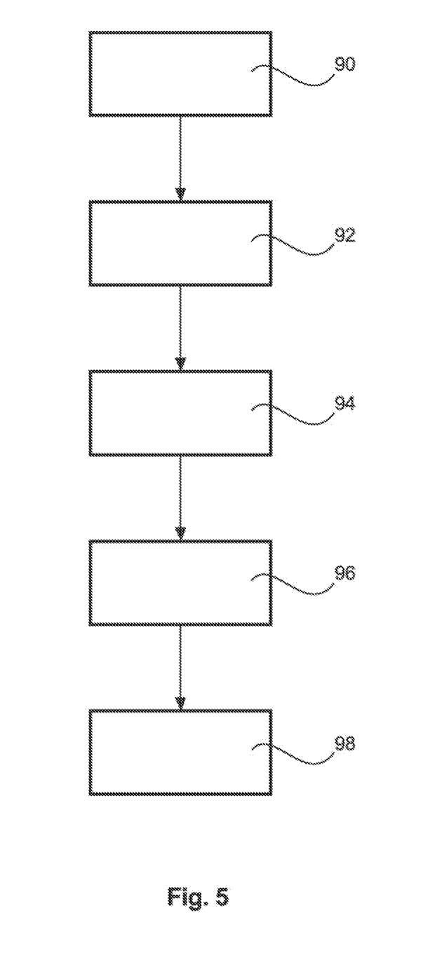

FIG. 5 further illustrates the method according to the invention based on a schematic block diagram. For example, the method according to the invention comprises the manufacture 90 of at least two shell sections out of a composite fiber material. This manufacturing process may involve laying and laminating fiber mats or fiber bundles. This procedural step is followed by the binding 92 of at least one compensation body comprised of a plastically deformable material to at least one limiting edge of at least one of the fabricated shell sections. Binding may involve all the joining methods specified above, for example positive joining, integral material joining through lamination or the like, or adhesive bonding. In another procedural step, the shell sections are overlapped 94, thereby yielding a shell accompanied by the formation of flat seams between respectively adjacent shell sections. At least one compensation body is situated in at least one of the seams. Changing the shape 96 of the compensation body compensates for dimensional deviations in each overlap. As a last step, the shell sections are joined 98 to the seams.

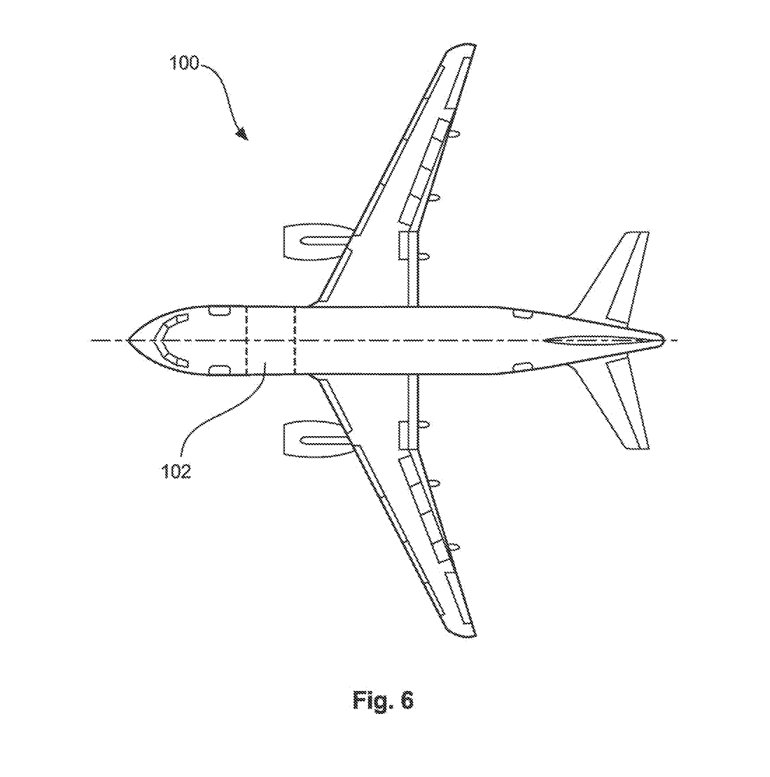

Finally, FIG. 6 shows an aircraft 100, which comprises one or more fuselage sections 102 fabricated based on the method according to an embodiment of the invention. For example, such a fuselage section 102 may be composed of one or more shell bodies, which in turn are fabricated out of individual shell sections based on the method according to an embodiment of the invention.

In addition, it must be pointed out that “comprising” or “encompass” do not preclude any other elements or steps, and that “a” or “the” do not rule out a plurality. Let it further be noted that features or steps described with reference to one of the above exemplary embodiments can also be described in combination with other features or steps from other exemplary embodiments described above. Reference numbers in the claims must not be construed as a limitation. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment of the invention, it being understood that various changes may be made in the function and arrangement of elements described in an exemplary embodiment without departing from the scope as set forth in the appended claims and their legal equivalents.

What is claimed is:

1. A method for fabricating a shell, comprising:
manufacturing at least two shell sections out of a composite fiber material, each having at least one limiting edge;
binding at least one compensation body comprised of a plastically deformable material to at least one limiting edge of at least one shell section through laminating into the composite fiber material of a shell body;
overlapping the at least two shell sections to yield the shell body accompanied by formation of flat seams between respectively adjacent shell sections, wherein the at least one compensation body is situated in at least one of the seams;
changing a shape of the at least one compensation body to compensate for dimensional deviations in each overlap; and
joining the shell sections at the seams.

2. The method of claim 1, further comprising arranging a plurality of compensation bodies on the shell sections so that at least one respective compensation body is situated on all the seams.

3. The method of claim 1, wherein the at least one compensation body is configured as a fold-like element comprising a contour that follows the contour of the shell sections.

4. The method of claim 1, further comprising molding at least areas of the shell sections as a cylinder barrel segment.

5. A shell body, comprising:
a first shell section of a composite fiber material;
a second shell section of the composite fiber material that overlaps the first shell section to yield at least one flat seam; and
a compensation body secured to the first shell section through lamination into the composite fiber material that is positioned in at least one seam to compensate.

6. A fuselage section, comprising:
at least one shell body comprised of a composite fiber material that has at least two overlapping shell sections that form at least one flat seam;
a compensation body secured to at least one of the at least two overlapping shell sections through lamination into the composite fiber material and positioned in at least one seam.
